(19) United States
(12) Patent Application Publication
(10) Pub. No.: US 2026/0053219 A1
(43) Pub. Date: Feb. 26, 2026

(54) STATIC DISSIPATIVE PROTECTIVE GLOVE

(71) Applicant: ANSELL LIMITED, Victoria (AU)

(72) Inventors: Ahmad Helmi Bin UJAR, Shah Alam, Selangor (MY); Wan Ashruzi Bin WAN AHMAD, Klang, Selangor (MY); Norazilayati Binti RASTAM, Shah Alam, Selangor (MY); Geraldo Alexandre PIMENTEL DE OLIVEIRA, Coimbra (PT); Mohd Zabidi MOHD YASIR, Selangor (MY); Hamidon Zain Bin MOHAMMED, Klang, Selangor (MY); Laksamee SRISUWAN, Khet Lat Krabang, Bangkok (TH)

(21) Appl. No.: 19/104,273

(22) PCT Filed: Aug. 15, 2023
(86) PCT No.: PCT/AU2023/050767

§ 371 Date: Feb. 17, 2025

Related U.S. Application Data
(60) Provisional application No. 63/398,383, filed on Aug. 16, 2022.

(51) Int. Cl. A41D 19/00; B29C 41/00; B29C 41/14; B29C 41/46; B29K 9/00; B29K 507/04; B29L 31/48; C08K 3/04; C08L 9/04

(52) U.S. Cl. CPC A41D 19/0055; B29C 41/003; B29C 41/14; B29C 41/46; C08K 3/041; C08L 9/04; B29K 2009/00; B29K 2507/04; B29K 2995/0005; B29L 2031/4864; C08K 2201/001; C08K 2201/005; C08L 2201/52

(57) ABSTRACT

A static dissipative single use glove having a vertical resistivity of less than about 10⁸ Ohm when determined according to EN 1149-2 and surface resistivity of less than or equal to about 10⁶ Ohm when determined according to EN 1149-1, which includes a polymeric layer comprising conductive filler particles. A method to produce the single use glove is also disclosed.

### FIELD

The instant disclosure is generally directed to protective articles and, more particularly, to protective articles such as a single use glove and/or other wearable articles that include protective polymeric layer(s), which dissipate electrostatic charge via addition of an electrically conductive filler into at least one of the polymeric layers from which the article is formed.

### BACKGROUND

Protective articles, such as gloves, sleeves, and the like, which are worn in industrial and/or household settings, have polymeric barriers disposed thereon. However, such articles do not typically allow an end user to interact with touchscreens and other capacitive sensing electronics, and typically lack dissipation of charge for use in certain environments.

If two materials are brought into contact and are rubbed together, an exchange of electrostatic charges (static electricity) occurs. When those charges are not dissipated, the electrostatic charge accumulates, and electrostatic discharges can happen spontaneously. In certain environments, electrostatic discharge can have disastrous effects. While gloves and other protective equipment are required in most industrial settings, polymeric gloves and other protective equipment do not typically have electrostatic dissipation characteristics which render their use suitable in some environments.

Means of dissipating electrostatic charge to prevent electrostatic discharge (ESD) are required in electrostatic protected areas (e.g., EPA or ESD areas), as well as in certain industries such as when working with electronic devices, components or sub-assemblies, which may be damaged or weakened by electrostatic discharges. Examples of such industries which require ESD protection include electronics, automotive, consumer products, and the like.

Another industry in which ESD protection is required is in explosive atmosphere areas (ATEX areas) wherein fumes, dust, or other materials generate a risk of explosion in the event of an electrostatic discharge. Examples include the chemical industry, pharmaceutical industry, and in farming (e.g., grain silos).

Various standards exist which specify the requirements of gloves and other protective equipment considered suitable for use in an explosive atmosphere or ATEX areas. According to EN 16350, an ATEX glove must have a vertical resistance below 10⁸ Ohms (Ω) when determined at 25% relative humidity.

In addition, polymeric gloves often inhibit an end user from interacting with various computer inputs, e.g., touchscreens, switches, sensors, and the like, due to poor electrostatic dissipative characteristics, rendering their use unsuitable during examinations or other procedures which require interaction with various computer or other capacitive sensing electronic equipment.

There is a need for single use gloves and other pieces of protective equipment having improved electrostatic dissipative characteristics.

With the foregoing in view, the inventors have invented polymeric gloves, which include single use polymeric gloves, having a vertical resistivity of less than or equal to about 10⁸ Ohm when determined according to EN 1149-5:2018, rendering them suitable for use in ATEX environments, and which allow end users to interact with touchscreen and other capacitively triggered electronic equipment while wearing the gloves.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter. In embodiments, static dissipative protective gloves are disclosed, including single use gloves, and methods for manufacturing the static dissipative protective gloves, substantially as shown in and/or described in connection with at least one of the figures, as set forth more completely in the claims. Various advantages, aspects and novel features of the present disclosure, as well as details of an illustrated embodiment thereof, will be more fully understood from the following description and drawings.

### DESCRIPTION OF THE DRAWINGS

So that the manner in which the above recited features of embodiments of the instant disclosure can be understood in detail, a more particular description of the embodiments, briefly summarized above, may be had by reference to embodiments, some of which are illustrated in the appended drawings. It is to be noted, however, that the appended drawings illustrate only illustrative embodiments of this disclosure and are therefore not to be considered limiting of its scope, for the invention disclosed herein may admit to other equally effective embodiments.

FIG. 1 depicts a single use glove having conductive filler particles, according to embodiments disclosed herein;

FIG. 2 depicts a close up view of the single use glove of FIG. 1, according to embodiments disclosed herein; and

FIG. 3 depicts a method for forming a single use glove comprising a polymer layer comprising conductive filler according to embodiments disclosed herein.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Likewise, each limitation of an embodiment should be read once as comprising that embodiment, then again as consisting essentially of that embodiment, then again as consisting of that embodiment, unless otherwise indicated. For brevity, the term comprising is used throughout unless otherwise indicated.

The following definitions are provided in order to aid those skilled in the art in understanding the detailed description.

As used in the specification and claims, “near” is inclusive of “at.” For use herein, the expressions “have”, “may have”, “include”, “comprise”, “may include”, and “may comprise” indicate the existence of corresponding features (e.g., such as numeric values, functions, operations, or components) but do not exclude the presence of additional features.

In the present disclosure, expressions such as, “A or B” represents an alternative selection which, for example, refer to the case (1) where A is included or (2) where B is included, but does not represent the case where both A and B are included.

In the present disclosure, expressions such as, “A and/or B”, “at least one of A and/or B”, “one or more of A and/or B”, and the like, refer to a case which may include any and all combinations of one or more of the associated listed items. For example, the terms “A and/or B”, and “at least one of A or B” may refer to the case (1) where A is included, (2) where B is included, or (3) where both A and B are included.

Terms such as “first”, “second”, and the like used herein may refer to various elements of various embodiments disclosed herein, but it is to be understood that these labels do not limit the elements to any particular order, amount, or importance; such terms are used only to distinguish an element from another element and do not limit the order and/or priority of the elements. Likewise, such terms are used relative to others and do not represent absolute location, place, or order. For example, without departing from the scope of the present disclosure, a first element of one embodiment may be referred to as a second element in another embodiment, and similarly, a second element may be referred to as a first element.

As used herein, “phr” refers to per hundred parts rubber by mass unless otherwise specified, wherein the “rubber” refers to the elastomeric polymer.

For purposes herein, the conductive filler may comprise, or consist of carbon black, carbon nanotubes, or a combination thereof. Reference to carbon black refers to paracrystalline carbon having a relatively high surface-area-to-volume or surface-area-to mass ratio.

For purposes herein, reference to a particulate component, e.g., the conductive filler having a minimum particle size and a maximum particle size refers to at least 95% of the material by mass, having a particle size greater than or equal to the specified minimum value and at least 95% of the material by mass has a particle size less than or equal to the specified maximum value. This designation acknowledges that the particulate component may include less than about 5 wt % of fines, and/or agglomerates may be present at levels which do not significantly affect the intended properties of the final product or article in which they are present. For purposes herein, particle size refers to the longest dimension of a particle unless otherwise specified.

The polymeric glove may further comprise one or more polymer layers covering a user's fingers, the palm, or both having a thickness of greater than or equal to about 0.05 mm, and less than or equal to about 0.2 mm. Likewise, the polymeric glove may further comprise a thickness of the palm area of greater than or equal to about 0.07 mm, or greater than or equal to about 0.08 mm, and less than or equal to about 0.17 mm, or less than or equal to about 0.15 mm. The thickness of the palm area may be greater than or equal to about 0.07 mm and less than or equal to about 0.15 mm. The thickness of the palm area may preferably be greater than or equal to about 0.08 mm, and less than or equal to about 0.17 mm. The polymeric glove may further have a vertical resistivity of less than about 10⁸ Ohm when determined according to EN 1149-2. Likewise, the polymeric glove may further have a surface resistivity of less than about 10⁶ Ohm when determined according to EN 1149-1. The polymeric glove may further comprise a static decay which is less than 0.01 seconds for a half decay time t50(s) when determined according to EN 1149-3. At least one of the polymer layers of the polymeric glove may further comprise greater than or equal to about 2 phr and less than or equal to about 15 phr of the conductive filler. The conductive filler of the polymeric glove may have a minimum particle size of greater than or equal to about 2 micrometers and a maximum particle size of less than or equal to about 10 micrometers. The conductive filler of the at least one layer may preferably have an average particle size of greater than or equal to about 2 micrometers and less than or equal to about 5 micrometers.

The polymer layer of the glove may further have a vertical resistivity of less than or equal to about 10⁵ Ohm when determined according to EN 1149-2. Preferably, the polymer layer has a surface resistivity of less than or equal to about 10⁶ Ohm according to EN 1149-1. The polymer layer may further have a static delay of less than or equal to about 0.01 seconds for a half decay time t50(s) when determined according to EN 1149-3. The polymer layer may further have a vertical resistivity of less than or equal to about 10⁵ Ohm when determined according to EN 1149-2. Preferably, the polymer layer has a surface resistivity of less than or equal to about 10⁶ Ohm according to EN 1149-1, and a static delay of less than or equal to about 0.01 seconds for a half decay time t50(s) when determined according to EN 1149-3 The polymeric glove may further have a chemical permeability which exceeds a 30 minute breakthrough time for heptane. The polymeric glove may further have a chemical permeability which exceeds a 30 minute breakthrough time for sodium hydroxide when determined according to EN ISO 374 Type B. The polymeric glove may further have a chemical permeability which exceeds a 30 minute breakthrough time for hydrogen peroxide when determined according to EN ISO 374 Type B. The polymeric glove may further have a chemical permeability which exceeds a 30 minute breakthrough time for formaldehyde when determined according to EN ISO 374 Type B. Preferably, the polymeric glove further a has a chemical permeability which exceeds a 30 minute breakthrough time for heptane, sodium hydroxide, hydrogen peroxide and formaldehyde when determined according to EN ISO 374 Type B.

The elastomer which forms at least one polymer layer of the polymeric glove may comprise, or consists essentially of, or consists of polyisobutylene. The elastomer which forms at least one polymer layer of the polymeric glove may comprise, or consists essentially of, or consists of polychloroprene. The elastomer which forms at least one polymer layer of the polymeric glove may comprise, or consists essentially of, or consists of ethylene vinyl acetate. The elastomer which forms at least one polymer layer of the polymeric glove may comprise, or consists essentially of, or consists of ethylene methyl acrylate The elastomer which forms at least one polymer layer of the polymeric glove may comprise, or consists essentially of, or consists of ethylene-propylene rubber. The elastomer which forms at least one polymer layer of the polymeric glove may comprise, or consists essentially of, or consists of ethylene-propylene diene rubber. The elastomer which forms at least one polymer layer of the polymeric glove may comprise, or consists essentially of, or consists of natural rubber The elastomer which forms at least one polymer layer of the polymeric glove may comprise, or consists essentially of, or consists of polyisoprene. The elastomer which forms at least one polymer layer of the polymeric glove may comprise, or consists essentially of, or consists of polyurethane. The elastomer which forms at least one polymer layer of the polymeric glove may comprise, or consists essentially of, or consists of nitrile butadiene rubber (NBR). The elastomer which forms at least one polymer layer of the polymeric glove may comprise, or consists essentially of, or consists of carboxylated nitrile butadiene rubber. The elastomer which forms at least one polymer layer of the polymeric glove may comprise, or consists essentially of, or consists of polyisobutylene, polychloroprene, ethylene vinyl acetate, ethylene methyl acrylate, ethylene-propylene rubber, ethylene-propylene diene rubber, natural rubber, polyisoprene, polyurethane, nitrile butadiene rubber (NBR), carboxylated nitrile butadiene rubber, or a combination thereof. Preferably, the elastomer which forms at least one polymer layer of the polymeric glove may comprise, or consists essentially of, or consists of acrylonitrile-butadiene rubber (NBR), carboxylated nitrile butadiene rubber, or a combination thereof.

The polymeric glove may further comprise at least a portion of an external surface which has a textured surface.

The polymeric glove may be formed from an aqueous emulsion comprising an elastomer comprising acrylonitrile derived moieties and butadiene derived moieties. The polymeric glove may be formed from an aqueous emulsion comprising greater than or equal to about 5 phr and less than or equal to about 15 phr conductive filler. The polymeric glove may be formed from an aqueous emulsion comprising an elastomer comprising conductive filler having a minimum particle size of greater than or equal to about 2 micrometers and a maximum particle size of less than or equal to about 10 micrometers. The polymeric glove may be formed from an aqueous emulsion comprising a surfactant system. Preferably, the polymeric glove is formed from an aqueous emulsion comprising: an elastomer comprising acrylonitrile derived moieties and butadiene derived moieties; greater than or equal to about 5 phr and less than or equal to about 15 phr conductive filler having a minimum particle size of greater than or equal to about 2 micrometers and a maximum particle size of less than or equal to about 10 micrometers, and a surfactant system.

In addition the polymeric glove may be formed from an aqueous emulsion comprising a surfactant system comprising a diol moiety. The diol moiety may include ethylene glycol, 1,2 propanediol, 1,3 propanediol, butanediols (e.g., 1,2 butanediol, 1,3 propanediol, 1,4 butanediol, 2,3 butanediol, and/or the like; pentanediols, e.g., 1,5 pentanediol, 1,3 pentanediol, 2,3 pentanediol, and/or the like; hexanediols, e.g., 1,6 hexanediol, 2,5 hexanediol, and/or the like; substituted diols, e.g., 2-methyl 2,4 pentanediol, 2-methyl 2,3 butanediol, and/or the like; triol moieties such as glycerin, trimethylolpropane, hexanetriols, e.g., 1,2,6 hexanetriol, 1,3,5-hexanetriol, and/or the like; trialkanol amines, e.g., triethanolamine, and/or the like; tetraol moieties including petaerythrito, diglycerin, and/or the like; petanol moieties including glucose, furanose, and/or the like; hexanol moieties including sorbitol, mannitol, and/or the like; octanol moieties including sucrose, and/or the like; lower alkylene oxide addition products of these compounds; and/or lower alkylene oxide copolymers of these compounds, e.g., ethylene oxide, propylene oxide, butylene oxide, and/or the like.

The polymeric glove may be formed by a method comprising:
a) coating a glove former in an aqueous coagulant solution to produce a coagulant coated former;
b) coating the coagulant coated former with a rubber dispersion;
c) curing the rubber coated on the coagulant coated former to produce a polymer layer thereon; and
d) obtaining a single use glove according to any one of the embodiments disclosed herein by removing the polymer layer from the former.

The method to form the polymeric glove may include a rubber dispersion comprising an aqueous emulsion comprising an elastomer; and greater than or equal to about 5 phr and less than or equal to about 15 phr conductive filler. The rubber dispersion used to form the polymeric glove may comprise an aqueous emulsion comprising a conductive filler having a minimum particle size of greater than or equal to about 2 micrometers and a maximum particle size of less than or equal to about 10 micrometers.

The polymeric glove may be formed by coating the coagulant coated former with a rubber dispersion includes drying the rubber coated on the coagulant coated former, andpreferably, coating the dried rubber coated on the coagulant coated former with a second layer of rubber dispersion.

The rubber dispersion from which the polymeric glove is formed may comprise an aqueous emulsion comprising a surfactant system, or a surfactant having an HLB of less than about 15.

The polymeric glove may further comprise one or more polymeric or elastomeric layers. In the alternative, the polymeric glove is formed from a single polymer layer.

The polymeric glove comprises at least one polymer layer, also referred to herein as an elastomeric layer, that further comprises a conductive filler. The conductive filler preferably is, or comprises carbon black. The conductive filler may be, or may comprise carbon nanotubes. The conductive filler preferably comprises carbon black and carbon nanotubes.. The conductive filler may be present in an amount effective to dissipate electrostatic charge and to impart a vertical resistivity into the article of less than or equal to about 10⁸ Ohm, when determined according to EN 1149-2. The conductive filler may be present at a concentration which results in a surface resistivity of less than or equal to about 10⁶ Ohm, when determined according to EN 1149-1. The conductive filler may be present in an amount effective to result in static decay which is less than or equal to about 0.01 seconds for a half decay time t50(s) when determined according to EN 1149-3. The conductive filler is preferably present in an amount effective to dissipate electrostatic charge and to impart a vertical resistivity into the article of less than or equal to about 10⁸ Ohm, when determined according to EN 1149-2, and result in a surface resistivity of less than or equal to about 10⁶ Ohm, when determined according to EN 1149-1, and produce a static decay which is less than or equal to about 0.01 seconds for a half decay time t50(s) when determined according to EN 1149.

The polymeric glove may further comprise a plurality of conductive filler particles disposed within the polymer layer which forms the single use glove. The polymeric glove may be unsupported. In the alternative, the polymeric glove is a supported glove. Inherent in being a glove, the polymeric glove comprises a pinky finger, a ring finger, a middle finger, an index finger, a thumb, and a palm component. The polymeric glove may further include a beaded cuff. The polymeric glove comprises a polymer layer comprising a plurality of conductive filler particles. The polymeric glove may further comprise a plurality of polymer layers comprising a plurality of conductive filler particles.

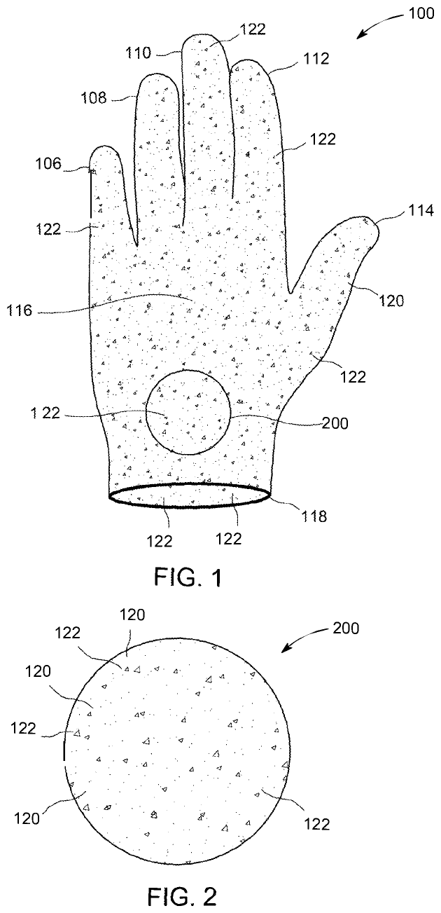

FIG. 1 depicts an unsupported single use glove 100 having a plurality of conductive filler particles 122 disposed within the polymer layer which forms the single use glove according to embodiments of the instant disclosure. Although shown as an unsupported single use glove for example only, the embodiments disclosed herein equally apply to supported gloves as well. The single use glove 100 comprises a pinky finger 106, a ring finger 108, a middle finger 110, an index finger 112, a thumb 114, a palm component 116, and a beaded cuff 118. The unsupported single use glove 100 comprises a polymer layer 120 comprising a plurality of conductive filler particles 122.

The polymeric glove may comprise a polymer layer comprising a plurality of the conductive filler particles. The polymeric glove may comprise conductive filler particles present within the polymer layer at a concentration of greater than or equal to about 5 phr and less than or equal to about 15 phr. The conductive filler particles may have a minimum particle size of greater than or equal to about 2 micrometers and a maximum particle size of less than or equal to about 10 micrometers. The conductive filler particles may have a size range from about 2 to 5 microns.

FIG. 2 depicts a close up view 200 of the single use glove 100 of FIG. 1, according to embodiments disclosed herein. The close up view 200 shows that the polymer layer 120 comprising a plurality of the conductive filler particles 122. The conductive filler particles 122 are present within the polymer layer at a concentration of greater than or equal to about 5 phr and less than or equal to about 15 phr. The conductive filler particles have a minimum particle size of greater than or equal to about 2 micrometers and a maximum particle size of less than or equal to about 10 micrometers. The plurality of conductive filler particles 122 are not drawn to scale for ease of presentation and comprise different sizes. i.e., a particle size ranges from about 2 to 10 microns and, in some embodiments the particle size of the conductive filler particles ranges from about 2 to 5 microns.

Thepolymer layer may comprise acrylonitrile butadiene rubber. The polymer layer may comprise a blend of different acrylonitrile butadiene rubbers, e.g., carboxylated acrylonitrile butadiene, highly-carboxylated acrylonitrile butadiene, non-carboxylated acrylonitrile butadiene, and/or elastomers derived from acrylonitrile and butadiene having different average molecular weights, different relative compositions or proportions of acrylonitrile moieties to butadiene moieties, and the like. The polymer layer may comprise one or more blends of acrylonitrile butadiene rubbers with other elastomers. For example, in a preferred embodiment, the polymer layer may further comprise natural or synthetic polymer layers or mixtures or blends thereof. The polymer layer may comprise a natural latex, such as guayule or natural rubber. The polymer layer may comprise synthetic latexes, such as synthetic polyisoprene, acrylics, butyl latex, polychloroprene, aqueous-and/or non-aqueous-polyurethanes, styrene-butadiene, and the like. The polymer layer may comprise a mixture or a blend of a natural latex and a synthetic latex. Preferably, the polymer layer comprises a highly carboxylated acrylonitrile-butadiene latex, which for purposes herein is defined as being approximately 35-40 wt % carboxylated.

The method for forming the unsupported glove comprising a polymeric layer having a plurality of conductive filler particles disposed therein may begin or start with the undressed hand shaped former, which may be heated before proceeding.

The former may then be coated with a coagulant, for example, by dipping the former into a bath of the coagulant solution. the coagulant solution may also be applied thereto, such as by spraying. The coagulant solution may be an aqueous mixture. In the alternative, the coagulant solution may be an alcoholic mixture. The coagulant solution may comprise a concentration of 3-12% calcium citrate, calcium nitrate, calcium chloride, acetic acid, formic acid, and/or other salts and/or concentrations, as are known to those in the art.

The coagulant solution may be heated, e.g., at a temperature ranging from about 42° C. to 55° C. The method may further comprise allowing the excess coagulant solution to drip dry from the liner and/or the former, which in a preferred embodiment, is rotated so that the fingers of the former are pointed up and allowed to dry.

The method may further comprise dipping the undressed former into a polymeric or elastomeric composition as disclosed herein, forming the polymer layer (elastomer layer) thereon. The dipping step may be a palm dip. The dipping step may be a ¾ dip. The dipping step may be a knuckle dip. The dipping step may be a full dip. The polymer layer may then be allowed to drip down, i.e., fingers are pointing down, to allow excess dipping composition to drip off, and reducing the thickness of the polymer layer formed thereon.

The method may further comprise rotating the former having the polymer layer disposed thereon so that the polymer layer can dry in ambient air for several minutes. Preferably, the polymer layer is allowed to dry for approximately one hour. The method may comprise curing the polymer layer. Preferably, the unsupported polymer layer undergoes a curing step to cure the polymer layer within an oven at a temperature of greater than or equal to approximately 130° C. for at least ten minutes. The polymer layer may be cured in a staged process comprising different curing stages within different temperature ranges for different periods of time. For example, the polymer layer may be cured in a staged process comprising, for example, a first stage at 90° C. for fifteen minutes, a second stages at 100° C. for fifteen minutes, and a third stage at 130° C. for fifteen minutes.

The method may further comprise leaching or washing the polymer coating using water at an appropriate temperature. The former may be washed prior to coating with the coagulant and or a release layer may be disposed on the former prior to disposition of the coagulant to facilitate removal of the single use glove from the former once formed. The polymer layer may be cured, for example, at a temperature ranging between 90-130° C. The polymeric layer is preferably cured at, for example, 120° C. for approximately one hour. The method may comprise curing in an oven, such as an infrared oven, at, for example, 90° C. for approximately 10 to 20 minutes in a first curing stage, 100° C. for approximately 10 to 20 minutes, and at 130° C. for approximately 10 to 20 minutes, wherein a cured single use glove is formed. The single use glove is then removed and the process may be repeated. The method may further include beading the polymer layer to form a cuff prior to removing the single use glove from the former.

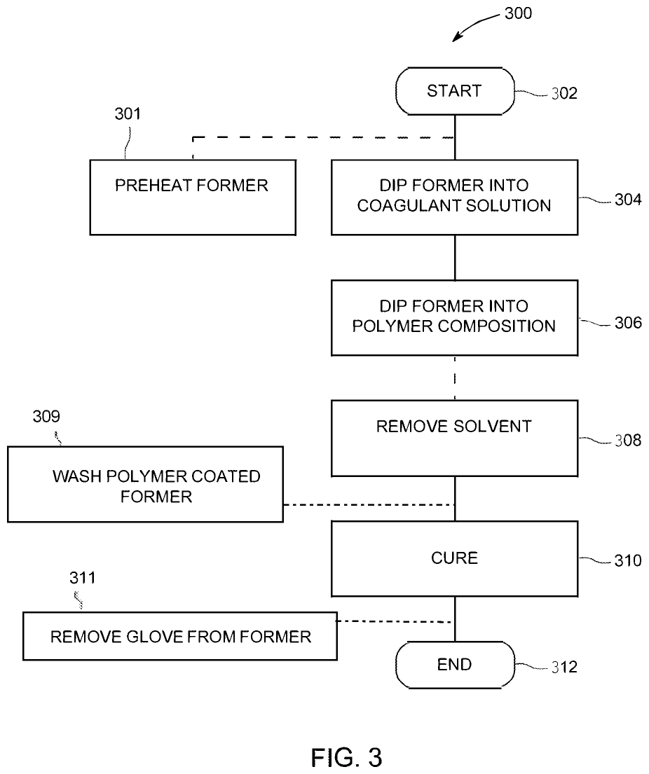

FIG. 3 depicts a method 300 for forming an unsupported single use glove comprising a polymeric layer 120 having a plurality of conductive filler particles 122 disposed therein according to embodiments of the instant disclosure. At step 302, the method 300 starts wherein with the undressed hand shaped former is provided. In some embodiments, the former is heated (step 301) before proceeding to step 304.

At block 304, the former is coated with a coagulant, for example, by dipping the former into a bath of the coagulant solution. the coagulant solution may also be applied thereto, such as by spraying. The coagulant solution may be an aqueous or alcoholic mixture comprising a concentration of 3-12% calcium citrate, calcium nitrate, calcium chloride, acetic acid, formic acid, and/or other salts and/or concentrations, as are known to those in the art.

In at least one embodiment, the coagulant solution is heated, e.g., at a temperature ranging from about 42° C. to 55° C. In some embodiments, excess coagulant solution is allowed to drip dry from the liner and/or the former, which may be rotated so that the fingers of the former are pointed up and allowed to dry.

At step 306, the undressed former is dipped into a polymeric or elastomeric composition according to embodiments disclosed herein, forming the polymer layer (elastomer layer) thereon. The dipping step may be a palm dip, a ¾ dip, a knuckle dip or a full dip as is known to those in the art. The polymer layer is allowed to drip down, i.e., fingers are pointing down, to allow excess dipping composition to drip off, and reducing the thickness of the polymer layer formed thereon.

At step 308, the former having the polymer layer disposed thereon is rotated so that the polymer layer can dry in ambient air for several minutes. In at least one embodiment, the polymer layer is allowed to dry for approximately one hour. At step 310, the unsupported polymer layer undergoes a curing step to cure the polymer layer, such as within an oven at a temperature of approximately 130° C. for ten minutes. In at least one embodiment, the polymer layer is cured in a staged process, for example, at a first stage at 90° C. for fifteen minutes, a second stage at 100° C. for fifteen minutes, and a third stage at 130° C. for fifteen minutes. At step 312, the method 300 ends.

In embodiments, the method to produce the single use glove according to embodiments disclosed herein is conducted using an apparatus suitable for conducting the method, comprising one or more controllers, conveyors, formers, tanks, ovens, and the like. In embodiments, the former may be metallic or ceramic, and is generally in the shape of a hand. The former may be in an arcuate shape, such as a partially closed hand or, alternatively, a flat shape.

In embodiments, the polymer coating may be leached or washed (step 309) using water at an appropriate temperature. The former may be washed prior to coating with the coagulant and or a release layer may be disposed on the former prior to disposition of the coagulant to facilitate removal of the single use glove from the former once formed. In embodiments, the polymer layer is cured, for example, at a temperature ranging between 90-130° C. In some embodiments, the polymeric layer is cured at, for example, 120° C. for approximately one hour. The curing step(s) comprise, in some embodiments, curing in an oven, such as an infrared oven, at, for example, 90° C. for approximately 10 to 20 minutes in a first curing stage, 100° C. for approximately 10 to 20 minutes, and at 130° C. for approximately 10 to 20 minutes, wherein a cured single use glove is formed. The single use glove is then removed (step 311) and the process may be repeated. In some embodiments, the method further includes beading the polymer layer to form a cuff prior to removing the single use glove from the former.

The polymer layer may further be subjected to chlorination while either present on the former during at least one block of the process, or once the single use glove has been removed from the former, by immersing or otherwise contacting the single use glove with an aqueous solution comprising chlorine for a period of time sufficient to at least partially chlorinate the polymer. The chlorination may be in an aqueous chlorine solution containing from 500 to 15,000 ppm of chlorine. In a preferred embodiment, the aqueous chlorine solution contains from 1,000 to 10,000 ppm of chlorine. In some embodiments, the single use glove may undergo multiple chlorination steps at different steps of the production process, and after the single use glove is formed.

Also, some steps of the preceding method may be omitted or performed in a different sequence. Furthermore, additional steps may be employed. For example, the uncured polymer layer on the former may be stripped, washed, and dried after the curing step(s). Washing can be carried out at a temperature between approximately 25° C. and 60° C., for approximately 15 to 90 minutes. The single use gloves may then be dried in a tumble dryer for approximately 20 to 60 minutes at 50° C. to 70° C. Also, other processes may be applied before the curing step.

At least a portion of an external surface of the single use glove may have a textured surface. The texturization or wrinkling processes may comprise a salt-based texturization applied to polymer layer, as disclosed in commonly-assigned U.S. Pat. Nos. 8,522,363 and 7,771,644, each of which is incorporated by reference in its entirety. The single use glove having a textured external surface may comprise a textured external layer disposed over a portion of the polymer layer to impart texture to the outer surface. A portion of the former used to produce the single use glove may include one or more textured portions dimensioned and arranged to impart a textured surface on a portion of the single use glove formed using the textured former. For example, curing an elastomer coating formed on a former, wherein a grip-defining portion of the former has an Ra average roughness of about 7-14 micrometers, an Rsm Mean width of roughness about 500-720, an Rpc and a peak count of about 15-20, as disclosed in the like assigned U.S. Pat. No. 10,058,137 B2, the contents of which are incorporated by reference herein. In embodiments, the glove former has one or more surfaces on fingertip regions with an Ra average roughness of about 7-14 micrometers, an Rsm Mean width of roughness of about 500-720, and/or an Rpc, Peak count of about 15-20. In some embodiments, the fingertip regions of the glove former has an Rz Mean roughness depth of about 30-50 micrometers, an Rmax Largest roughness depth of about 40-70 micrometers, an Rp Height of the highest peak of about 8-22 micrometers, and/or an Rv Depth of deepest valley of about 16-35 micrometers, as disclosed in the like assigned U.S. Pat. No. 10,405,593 B2, the contents of which are incorporated by reference herein.

The polymeric glove maycomprise a second polymeric layer. For example, the method for making a single use glove may further comprise a step for disposing another polymer layer on the former described above. The polymer layer may optionally have a coagulant disposed thereon.

Single use gloves according to embodiments disclosed herein have been unexpectedly discovered to possess enhanced static electricity dissipation into the environment. The Applicant has discovered that both the relatively low amount of conductive filler in combination with the relatively large size and limited size range of the conductive filler, i.e., greater than or equal to about 5 phr and less than or equal to about 15 phr conductive filler having a minimum particle size of greater than or equal to about 2 micrometers and a maximum particle size of less than or equal to about 10 micrometers results in the unexpected benefit of a single use glove having a thickness of from about 0.05 mm to about 0.2 mm, with a vertical resistivity of less than or equal to about 10⁸ Ohms, which in embodiments, is determined according to EN 1149-2 as is currently defined at the time of filing of this application, and a surface resistivity of less than or equal to about 10⁶ Ohm, which in embodiments is determined according to EN 1149-1 as is currently defined at the time of filing of this application, and a static decay which is less than or equal to about 0.01 seconds for a half decay time t50(s), which in embodiments is determined according to EN 1149-3 as is currently defined at the time of filing of this application.

### Elastomeric Polymer

The at least one polymer layer may comprise an elastomer comprising polyisobutylene, polychloroprene, ethylene vinyl acetate, ethylene methyl acrylate, ethylene-propylene rubber, ethylene-propylene diene rubber, natural rubber, polyisoprene, polyurethane, nitrile-butadiene rubber, carboxylated nitrile-butadiene rubber, or a combination thereof.

The at least one polymer layer may comprise nitrile-butadiene rubber (NBR, carboxylated nitrile-butadiene rubber, or a combination thereof.

The polymer layer may comprise a blend of one or more nitrile-butadiene rubbers. The elastomer may comprise a blend of one or more nitrile-butadiene rubbers in combination with one or more of elastomers derived from isobutylene, chloroprene, ethylene vinyl acetate, vinyl acetate, ethylene methyl acrylate, ethylene-propylene rubber, ethylene-propylene diene rubber, natural rubber, synthetic polyisoprene, polyurethane, styrene, a-methylstyrene, dimethyl styrene, poly(meth)acrylamide, poly-N,N-dimethylacrylamide; polymethyl(meth)acrylate, polybutyl (meth)acrylate, 2-ethylhexyl (meth)acrylate, or a combination thereof.

The polymer layer may possess a minimum elongation of greater than or equal to about 400%, or greater than or equal to about 500%, or greater than or equal to about 600%, and a tensile strength of greater than or equal to about 14 MPa, when determined according to ASTM D412 or an equivalent thereof.

### Conductive Filler

The conductive filler suitable for use herein may include carbon black, such as acetylene black, channel black, furnace black, lamp black, thermal black, or a combination thereof.

In addition the carbon black suitable for use herein may be produced by the incomplete combustion of coal and coal tar, vegetable matter, or petroleum products. In embodiments, the carbon black is produced from fuel oil, fluid catalytic cracking tar, ethylene cracking, and/or the like.

The conductive filler suitable for use herein may include carbon nanotubes.

The conductive filler may be present within the polymer layer at a concentration of greater than or equal to about 2 phr, or greater than or equal to about 3 phr, or greater than or equal to about 4 phr, or greater than or equal to about 5 phr, or greater than or equal to about 6 phr, and less than or equal to about 15 phr, or less than or equal to about 13 phr, or less than or equal to about 10 phr, or less than or equal to about 9 phr, or less than or equal to about 8 phr, by mass.

The conductive filler may have a minimum particle size of greater than or equal to about 2 micrometers, or greater than or equal to about 3 micrometers, or greater than or equal to about 4 micrometers, or greater than or equal to about 5 micrometers. In embodiments, the conductive filler has a maximum particle size of less than or equal to about 10 micrometers, or less than or equal to about 8 micrometers, or less than or equal to about 7 micrometers, when determined according to methods known in the art.

The conductive filler may be present within the polymer layer has an average particle size of greater than or equal to about 2 micrometers, or greater than or equal to about 3 micrometers, or greater than or equal to about 4 micrometers and less than or equal to about 7 micrometers, or less than or equal to about 5 micrometers.

### Dipping Composition/Coating Emulsion

In addition to one or more other elements relating to particular embodiments of the single use glove, the gloves are formed by coating a former with an emulsion comprising the nitrile butadiene rubber, and greater than or equal to about 5 phr and less than or equal to about 15 phr conductive filler having a minimum particle size of greater than or equal to about 2 micrometers and a maximum particle size of less than or equal to about 10 micrometers. The solvent from the coating solution is then removed and the resulting layer present on the former is cured to form the polymer layer. This coating emulsion, also referred to in the art as a “dipping solution” or dipping composition further comprises a surfactant system which stabilizes the rubber and the conductive filler therein such that the components present in the polymer layer disposed on the former during the coating process are evenly distributed throughout the layer.

It is to be understood that while the coating emulsion may be referred to as a “dipping solution”, it is not a “clear” solution in the strict sense of the term, but instead is a heterogenous emulsion comprising the dispersed rubber polymer, the conductive filler, water and/or other solvents, stabilized by a surfactant system. The dipping solution may further include other components and additives.

In embodiments, the dipping solution and the polymer layer formed from the dipping solution may further include fillers, surfactants, waxes, paraffins, thickeners, rheology agents,, pigments, antioxidants, vulcanizing agents, such as sulfur, zinc oxides, rubber accelerators, activators, thioureas, benzothiazole sulphenamides, thiazoles, such as mercaptobenzothiazole, zinc mercaptobenzothiazole, dibenzodithiazyl disulphide, dialkyl dithiocarbamates, such as sodium dimethyldithiocarbarmate, zinc dimethyldithiocarbarmate, zinc diethyl dithiocarbamate, zinc dibutyldithiocarbamate, sodium diethyldithiocarbamate, sodium dibutyldithiocarbamate, zinc dibenzyldithiocarbamate, or combinations thereof; thiurams, such as tetramethyl thiuramdisulfide, tetraethyl thiuramdisulfide, teirabutyl thiuramdisulfide, dipentamethylene thiuramtetrasulfide or xanthogens, such as diisopropyl xanthogen polysulfide, dihydrocarbyl xanthogen polysulfide, dibutyl xanthogen polysulfide, anti-oxidants, anti-ozonants, rheology-modifiers, such as various clays and aluminosilicates, pH adjusters, such as hydroxides, such as potassium hydroxide, pigments, processing agents, and/or or combinations thereof; and the like. In embodiments, the dipping composition is formed by diluting a master-batch comprising the various components in corresponding ratios such that upon dilution, e.g., with water, a suitable dipping composition is produced.

In addition to one or more other elements relating to particular embodiments of the single use glove, the dipping solution from which the single use gloves are formed include greater than or equal to about 5 phr and less than or equal to about 15 phr conductive filler having a minimum particle size of greater than or equal to about 2 micrometers and a maximum particle size of less than or equal to about 10 micrometers. The components of the dipping solution are present as a stable emulsion in which water is the continuous phase. The components are emulsified by a surfactant system. In some embodiments, the surfactant has an hydrophobe to lipophobe balance (HLB) of less than about 15. In embodiments, the surfactant has an HLB of less than or equal to about 13, or less than or equal to about 12. In embodiments, the surfactant system comprises an ethoxylated moiety, which in embodiments comprises from about 5 to about 15 moles of ethylene oxide (5-15 EO), or from about 9 to 11 moles EO.

In addition to one or more other elements relating to particular embodiments of the single use glove, the dipping solution may include a blend of surfactants comprising dodecylbenzenesulfonates and/or aliphatic sulfonates; cationic sulfonates, cationic surfactants such as polyethylene glycol alkyl ethers, ethoxylated amines, ethoxylated quaternary amines, polyethylene glycol alkyl esters, ethoxylated diols, amino acid based surfactants, imidazoline surfactants, betaines, and/or the like.

In addition to one or more other elements relating to particular embodiments of the single use glove, the dipping solution may further comprise one or more curative agent(s), e.g., sulfur or sulfur donors. Flow and/or rheology modifiers, accelerator(s), and/or activators, such as zinc oxide, may be added to the nitrile-butadiene composition. In embodiments, water is added to form a nitrile-butadiene composition having approximately 30-40% such as 33% total solids content (TSC). In some embodiments, the dipping solution is essentially “solvent free” meaning that no organic solvents are present in dipping solution. In some embodiments, the dipping solution may include aliphatic carboxylic acids, and/or pH stabilizers. In some embodiments, the nitrile-butadiene resin is carboxylated. In some embodiments, the nitrile-butadiene is highly carboxylated, e.g., 35% or greater carboxylation.

### Esd Properties

In addition to one or more other elements relating to particular embodiments of the single use glove, the single use glove is EN16350 compliant, i.e., the single use glove comprises a vertical resistivity of less than about 108 Ohm (Ω) when determined according to EN ISO 1149-2, or an equivalent thereof, and surface resistivity of less than about 106 Ohm (Ω) when determined according to EN ISO 1149-1, or an equivalent thereof. In embodiments, the single use glove comprises a vertical resistivity of less than or equal to about 106 Ohm, or less than or equal to about 105 Ohm when determined according to EN ISO 1149-2, or an equivalent thereof. In some embodiments, the single use glove has a static decay which is less than or equal to about 0.01 seconds for a half decay time t50(s) when determined according to EN 1149-3, or an equivalent thereof.

### Chemical/Biological Protection

The single use glove may have a chemical permeability which exceeds a 30-minute breakthrough time to heptane, sodium hydroxide, hydrogen peroxide and formaldehyde, when determined according to EN ISO 374 Type B.

The single use gloves may comprise a polymer layer comprising conductive filler in the shape of a hand and having stalls for a thumb, an index finger, a middle finger, a ring finger, and a little finger for receiving the hand of a wearer. The conductive filler particles are present in the polymer layer at or equal to about 5 phr and less than or equal to about 15 phr and the conductive filler has a minimum particle size of greater than or equal to about 2 micrometers and a maximum particle size of less than or equal to about 10 micrometers.

The single use gloves may have a thickness of greater than or equal to about 0.05 mm to about 0.2 mm. In embodiments, the single use gloves have an average thickness from about 0.08 mm to about 0.15 mm. In embodiments, the ratio of the average particle size of the conductive filler to the average thickness of the single use glove is from about 0.06 to about 0.25.

The single use gloves are preferably suitable for use with touchscreens.

Embodiments contemplated herein include:

E1. A polymeric glove suitable for single use, comprising: one or more polymer layers covering a user's fingers and palm, wherein at least one of the polymer layers comprises greater than or equal to about 5 phr and less than or equal to about 15 phr of a conductive filler having a minimum particle size of greater than or equal to about 2 micrometers and a maximum particle size of less than or equal to about 10 micrometers, and wherein the polymeric glove has a vertical resistivity of less than about 108 Ohms.
E2. The polymeric glove according to embodiment E1, having a thickness of from about 0.05 mm to about 0.2 mm.
E3. The polymeric glove according to embodiment E1 or E2, having a thickness of from about 0.08 mm to about 0.15 mm.
E4. The polymeric glove according to one or more of embodiments E1 through E3, wherein the conductive filler has an average particle size of greater than or equal to about 2 micrometers and less than or equal to about 5 micrometers.
E5. The polymeric glove according to one or more of embodiments E1 through E4, having a vertical resistivity of less than or equal to about 105 Ohms.
E6. The polymeric glove according to one or more of embodiments E1 through E5, having a chemical permeability which exceeds a 30-minute breakthrough time for one or more of heptane, sodium hydroxide, hydrogen peroxide and formaldehyde.
E7. The polymeric glove according to one or more of embodiments E1 through E6, wherein at least one of the polymer layers comprises a cross-linked elastomer.
E8. The polymeric glove according to one or more of embodiments E1 through E7, where the at least one polymer layer comprises polyisobutylene, polychloroprene, ethylene vinyl acetate, ethylene methyl acrylate, ethylene-propylene rubber, ethylene-propylene diene rubber, natural rubber, polyisoprene, polyurethane, nitrile-butadiene rubber, carboxylated nitrile-butadiene rubber, or a combination thereof.
E9. The polymeric glove according to one or more of embodiments E1 through E8, wherein at least one of the polymer layers comprises nitrile-butadiene rubber.
E10. The polymeric glove according to one or more of embodiments E1 through E9, wherein at least a portion of an external surface of the glove has a textured surface.
E11. The polymeric glove according to one or more of embodiments E1 through E10 formed from an aqueous emulsion comprising:
a latex emulsion comprising one or more elastomers; and
greater than or equal to about 5 phr and less than or equal to about 15 phr conductive filler having a minimum particle size of greater than or equal to about 2 micrometers and a maximum particle size of less than or equal to about 10 micrometers.
E12. The polymeric glove according to one or more of embodiments E1 through E11, wherein the aqueous emulsion further comprises a surfactant system having an HLB of less than about 15.
E13. The polymeric glove according to one or more of embodiments E1 through E12, wherein the conductive filler comprises carbon black.
E14. The polymeric glove according to one or more of embodiments E1 through E13, wherein the conductive filler comprises carbon nanotubes.
E15. The polymeric glove according to one or more of embodiments E1 through E14, having a surface resistivity of less than or equal to about 106 Ohm.
E16. The polymeric glove according to embodiment E15, wherein the surface resistivity is determined according to EN 1149-1.
E17. The polymeric glove according to one or more of embodiments E1 through E16 having a static decay of less than or equal to about 0.01 seconds for a half decay time t50(s).
E18. The polymeric glove according embodiment E17, wherein the static decay is determined according to EN 1149-3.
E19. The polymeric glove according to one or more of embodiments E1 through E18, wherein the vertical resistivity is determined according to EN 1149-2.
E20. The polymeric glove according to one or more of embodiment E6, wherein the chemical permeability is determined according to EN ISO 374-3 Type B.
E21. A method to produce a single use glove according to one or more of embodiments E1 through E20, comprising:
coating a glove former in an aqueous coagulant solution to produce a coagulant coated former;
   coating the coagulant coated former with a rubber dispersion;
   curing the rubber coated on the coagulant coated former to produce a polymer layer thereon; and
   obtaining a glove, by removing the polymer layer from the former, comprising one or more polymer layers covering a user's fingers and palm, wherein at least one of the polymer layers comprises greater than or equal to about 5 phr and less than or equal to about 15 phr of a conductive filler having a minimum particle size of greater than or equal to about 2 micrometers and a maximum particle size of less than or equal to about 10 micrometers, and wherein the polymeric glove has a vertical resistivity of less than about 108 Ohms.
   E22. A method to produce a single use glove, comprising:
coating a glove former in an aqueous coagulant solution to produce a coagulant coated former;
   coating the coagulant coated former with a rubber dispersion;
   curing the rubber coated on the coagulant coated former to produce a polymer layer thereon; and
   obtaining a glove, by removing the polymer layer from the former, comprising one or more polymer layers covering a user's fingers and palm, wherein at least one of the polymer layers comprises greater than or equal to about 5 phr and less than or equal to about 15 phr of a conductive filler having a minimum particle size of greater than or equal to about 2 micrometers and a maximum particle size of less than or equal to about 10 micrometers, and wherein the polymeric glove has a vertical resistivity of less than about 108 Ohms.
   E23. The method according to embodiments E21 or E22, wherein the rubber dispersion comprises an aqueous emulsion comprising: an elastomer; and greater than or equal to about 5 phr and less than or equal to about 15 phr of a conductive filler having a minimum particle size of greater than or equal to about 2 micrometers and a maximum particle size of less than or equal to about 10 micrometers.
   E24. The method according to one or more of embodiments E21 through E23, wherein the rubber dispersion comprises a surfactant system having an HLB of less than about 15.
   E25. The method according to one or more of embodiments E21 through E24, wherein the rubber dispersion comprises at least one of polyisobutylene, polychloroprene, ethylene vinyl acetate, ethylene methyl acrylate, ethylene-propylene rubber, ethylene-propylene diene rubber, natural rubber, polyisoprene, polyurethane, nitrile-butadiene rubber, carboxylated nitrile-butadiene rubber, or a combination thereof.
   E26. The method according to one or more of embodiments E21 through E25, wherein the polymer layer comprises greater than or equal to about 5 phr and less than or equal to about 15 phr of a conductive filler comprising carbon black, carbon nanotubes, or a combination thereof, having a minimum particle size of greater than or equal to about 2 micrometers and a maximum particle size of less than or equal to about 10 micrometers, and has a vertical resistivity of less than or equal to about 108 Ohms.
   E27. The method according to one or more of embodiments E21 through E26, wherein the polymer layer has a surface resistivity of less than or equal to about 106 Ohm, a static decay of less than or equal to about 0.01 seconds for a half decay time t50(s), or a combination thereof.

The foregoing disclosure and description of the invention is illustrative and explanatory thereof and it can be readily appreciated by those skilled in the art that various changes in the size, shape and materials, as well as in the details of the illustrated construction or combinations of the elements described herein can be made without departing from the spirit of the invention.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any elements of any of the claims herein, except for those in which the claim expressly uses the words ‘means for’ together with an associated function.

All numerical values recited herein are exemplary, are not to be considered limiting, and include ranges therebetween, and can be inclusive or exclusive of the endpoints. Optional included ranges can be from integer values therebetween, at the order of magnitude recited or the next smaller order of magnitude. For example, if the lower range value is 0.1, optional included endpoints can be 0.2, 0.3, 0.4. 1.1, 1.2, and the like, as well as 1, 2, 3 and the like; if the higher range is 10, optional included endpoints can be 7, 6, and the like, as well as 7.9, 7.8, and the like.

To facilitate understanding, identical reference numerals have been used, where possible, to designate comparable elements that are common to the figures. The figures are not drawn to scale and may be simplified for clarity. It is contemplated that elements and features of one embodiment may be beneficially incorporated in other embodiments without further recitation.

Publications and references, including but not limited to patents and patent applications, cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

We claim:

1. A polymeric glove suitable for single use, comprising: one or more polymer layers covering a user's fingers and palm, wherein at least one of the polymer layers comprises greater than or equal to about 5 phr and less than or equal to about 15 phr of a conductive filler having a minimum particle size of greater than or equal to about 2 micrometers and a maximum particle size of less than or equal to about 10 micrometers.

2. The polymeric glove of claim 1, having a thickness of from about 0.05 mm to about 0.2 mm.

3. The polymeric glove of claim 1, having a thickness of from about 0.08 mm to about 0.15 mm.

4. The polymeric glove of claim 1, wherein the conductive filler has an average particle size of greater than or equal to about 2 micrometers and less than or equal to about 5 micrometers.

5. The polymeric glove of claim 1, having a vertical resistivity of less than or equal to about 108 Ohms.

6. The polymeric glove of claim 1, having a chemical permeability which exceeds a 30-minute breakthrough time for one or more of heptane, sodium hydroxide, hydrogen peroxide and formaldehyde.

7. The polymeric glove of claim 1, wherein at least one of the polymer layers comprises a cross-linked elastomer.

8. The polymeric glove of claim 1, where the at least one polymer layer comprises polyisobutylene, polychloroprene, ethylene vinyl acetate, ethylene methyl acrylate, ethylene-propylene rubber, ethylene-propylene diene rubber, natural rubber, polyisoprene, polyurethane, nitrile-butadiene rubber, carboxylated nitrile-butadiene rubber, or a combination thereof.

9. The polymeric glove of claim 1, wherein at least one of the polymer layers comprises nitrile-butadiene rubber.

10. (canceled)

11. The polymeric glove of claim 1, formed from an aqueous emulsion comprising: a latex emulsion comprising one or more elastomers; and greater than or equal to about 5 phr and less than or equal to about 15 phr conductive filler having a minimum particle size of greater than or equal to about 2 micrometers and a maximum particle size of less than or equal to about 10 micrometers.

12. The polymer glove of claim 11, wherein the aqueous emulsion further comprises a surfactant system having an HLB of less than about 15.

13. The polymeric glove of claim 1, wherein the conductive filler comprises carbon black and/or carbon nanotubes.

14. (canceled)

15. The polymeric glove of claim 1, having a surface resistivity of less than or equal to about 106 Ohm, wherein the surface resistivity is determined according to EN 1149-1.

16. (canceled)

17. The polymeric glove of claim 1, having a static decay of less than or equal to about 0.01 seconds for a half decay time t50(s), wherein the static decay is determined according to EN 1149-3.

18.-20. (canceled)

21. A method to produce a single use glove, comprising: coating a glove former in an aqueous coagulant solution to produce a coagulant coated former; coating the coagulant coated former with a rubber dispersion; curing the rubber coated on the coagulant coated former to produce a polymer layer thereon; and obtaining a glove, by removing the polymer layer from the former, comprising one or more polymer layers covering a user's fingers and palm, wherein at least one of the polymer layers comprises greater than or equal to about 5 phr and less than or equal to about 15 phr of a conductive filler having a minimum particle size of greater than or equal to about 2 micrometers and a maximum particle size of less than or equal to about 10 micrometers.

22. The method of claim 21, wherein the rubber dispersion comprises an aqueous emulsion comprising: an elastomer; and greater than or equal to about 5 phr and less than or equal to about 15 phr of a conductive filler having a minimum particle size of greater than or equal to about 2 micrometers and a maximum particle size of less than or equal to about 10 micrometers.

23. The method of claim 21-or 22, wherein the rubber dispersion comprises a surfactant system having an HLB of less than about 15.

24. The method of claim 21, wherein the rubber dispersion comprises at least one of polyisobutylene, polychloroprene, ethylene vinyl acetate, ethylene methyl acrylate, ethylene-propylene rubber, ethylene-propylene diene rubber, natural rubber, polyisoprene, polyurethane, nitrile-butadiene rubber, carboxylated nitrile-butadiene rubber, or a combination thereof.

25. The method of claim 21, wherein the polymer layer comprises greater than or equal to about 5 phr and less than or equal to about 15 phr of a conductive filler comprising carbon black, carbon nanotubes, or a combination thereof, having a minimum particle size of greater than or equal to about 2 micrometers and a maximum particle size of less than or equal to about 10 micrometers, and has a vertical resistivity of less than or equal to about 108 Ohms.

26. The method of claim 25, wherein the polymer layer has a surface resistivity of less than or equal to about 106 Ohm, a static decay of less than or equal to about 0.01 seconds for a half decay time t50(s), or a combination thereof.
